(19) United States
(12) Patent Application Publication
(10) Pub. No.: US 2003/0044489 A1
(43) Pub. Date: Mar. 6, 2003

(54) Dough extrusions for producing baked products having multiple textures

(76) Inventors: Antonio-Helio Waszyk, Belmont s/Lausanne (CH); Rupak Bajracharya, Newtown, CT (US); Robert E. Ross, Trumbull, CT (US)

Correspondence Address: WINSTON & STRAWN, PATENT DEPARTMENT, 1400 L STREET, N.W., WASHINGTON, DC, 20005-3502, US

(21) Appl. No.: 10/230,156

(22) Filed: Aug. 29, 2002

Related U.S. Application Data
(63) Continuation-in-part of application No. 09/942,616, filed on Aug. 30, 2001.

(51) Int. Cl. A23G 3/00

(52) U.S. Cl. 426/94

(57) ABSTRACT

The invention relates to a dough product having multiple textures, flavors, and colors after baking. The dough product is typically in the form of a cylinder or elongated block having a circular or polygonal cross-sectional area, and is refrigerated or frozen prior to use. The product is formed of two or more doughs having different properties after baking. For example, one of the doughs may be crispy and the other chewy. Preferably, after baking the center portion of the dough product would be chewy and the edge portion would be crispy.

### CROSS-REFERENCE TO RELATED APPLICATION

This application is a continuation-in-part of application Ser. No. 09/942,616, filed Aug. 30, 2001, now pending. The entire contents of the prior application is hereby incorporated herein by express reference thereto.

### FIELD OF INVENTION

The invention is directed to extruded dough which can be baked to provide products having different textures, flavors, or colors between a center portion of the baked product and an edge portion surrounding the center portion.

### BACKGROUND OF THE INVENTION

Chilled dough products currently exist wherein two or more doughs are extruded simultaneously to create decorative patterns when the doughs are baked. Examples include cookies marketed with holiday themes. The doughs differ primarily in color, which is achieved by adding artificial colors to the portion of the dough formed into the design and leaving the surrounding dough uncolored. Occasionally, the coloring may even yield a slight flavor difference between the doughs, such as for example, when cocoa powder is used to create a brown color.

Shelf-stable baked goods exist where a product has different textures, such as crispy and chewy portions. U.S. Pat. No. 4,717,570 discloses shelf-stable multi-textured cookies having a soft and moist center containing a humectant and a firm outer layer containing a mixture of casein and an edible, water-soluble phosphate. U.S. Pat. No. 4,840,803 discloses a shelf-stable multi-textured cookie having a soft and moist center containing a humectant and a firm outer layer containing a hard vegetable fat. U.S. Pat. No. 4,910,029 discloses a cookie having a shelf-stable plurality of textures and visually apparent flavor chips. U.S. Pat. Nos. 4,961,941 and 4,961,942 disclose a cookie having a shelf-stable plurality of textures. The cookie has an inner layer that includes a humectant and a water content that is greater than that of the outer layer.

As can be seen from the foregoing, thus far, dough products having different textures after baking are only available for shelf-stable products, and not for ready-to-bake chilled products. It is desirable in certain situations to obtain a chilled dough product that has two or more textures and provides other interesting visual and olfactory differences. Thus, it would be desirable to obtain a chilled dough product having such differences that was ready-to-bake, in which the dough product would exhibit such textural differences after being baked by the consumer.

### SUMMARY OF THE INVENTION

The invention relates to a ready-for-use dough product including a first dough portion and a second dough portion, wherein the dough portions are associated with each other for simultaneous baking, with the first dough providing a different texture and color, a different texture and flavor, or a different texture, color, and flavor from the second dough portion after the dough product is baked. In one embodiment, the first dough portion is surrounded by the second dough portion so that the first dough portion forms a center portion of the product and the second dough forms an edge portion of the dough.

In one embodiment, the center portion is made of a first dough formulation and the edge portion is made of a second dough formulation that is different from the first dough formulation. In one embodiment, the center dough portion is formulated to be softer than the edge dough portion after baking. In another embodiment, the center dough portion is formulated to be chewier than the edge dough portion after baking. In an additional embodiment, the center dough portion is formulated to have a moisture content of greater than about 7% and the edge dough portion is formulated to have a moisture content of less than about 6% after baking.

In another embodiment, the dough product is at least substantially cylindrical and the center dough portion is configured to have a periphery which forms a design. In another embodiment, the center dough portion has a circle, star, heart, tree, animal, or oval shape. In another embodiment, the center dough portion includes brownie dough and the edge dough portion includes cookie dough. In still another embodiment, the dough product is in the form of a cylinder or polygon having an outer perimeter of between about 1 cm to 8 cm and a length of about 10 cm to 25 cm. In another embodiment, one or both of the first and second dough portions includes pieces of chocolate, nuts, fruit, or candy inclusions in an amount of about 5% to 50% by weight of the dough, wherein the pieces are about 1 mm to 10 mm in size. In an additional embodiment, the first and second dough portions are sufficiently viscous to inhibit or avoid miscibility thereof. In another embodiment, the center portion has a diameter of about 1.5 cm to 4.75 cm and the edge portion has a width of about 0.25 cm to 1.5 cm. In yet another embodiment, the first and second dough portions are arranged to be longitudinally adjacent each other in the form of strips or longitudinal sections.

In one embodiment, the first and second dough portions each comprise a different bakery dough for forming a muffin, cracker, roll, biscuit, pie crust, bread, pizza dough, or bagel portion. In another embodiment, the dough is provided in sheet or block form having a generally uniform thickness and a surface that includes an imprint of grooves, score lines, or combinations thereof, that defines pieces of the dough to be broken off and baked, with the imprint extending into the thickness of the dough product. In one preferred embodiment, the imprint does not extend entirely through the thickness of the dough.

The invention also relates to a method of providing a dough product that includes providing first and second doughs which are formulated to differ in texture, color, and flavor after the dough product is baked; and associating the doughs together to form a dough product that can be baked so that, after cutting and baking, a baked product having portions with different textures is obtained. In one embodiment, the first and second doughs are co-extruded such that the first dough forms a center portion of the dough product and the second dough forms an edge portion of the dough product that surrounds the center portion.

In one embodiment, the center dough portion is formulated to be softer than the edge dough portion after the dough product is baked. In another embodiment, the center dough portion is formulated to be chewier than the edge dough portion after the dough product is baked. In another embodiment, the edge dough portion is chewier than the center dough portion. In yet another embodiment, the center dough portion is formulated to have a moisture content of greater than about 7% and the edge dough portion is formulated to have a moisture content of less than about 6% after the dough product is baked. In another embodiment, the first and second doughs are formulated to be sufficiently viscous to inhibit or avoid miscibility thereof. In another embodiment, the doughs are arranged in the form of a cylinder or polygon having an outer perimeter of about 1 cm to 8 cm and a length of about 10 cm to 25 cm. In another embodiment, the first and second doughs are arranged to be longitudinally adjacent each other in the form of strips or longitudinal sections.

In another embodiment, the dough product is coextruded in sheet or block form having a generally uniform thickness wherein the edge portion has a surface that includes an imprint of grooves, score lines, or combinations thereof, that defines pieces of the dough to be broken off and baked, with the imprint extending into the thickness of the dough. The dough can be stored in a refrigerated or frozen state prior to use and, in one preferred embodiment, the imprint does not extend entirely through the thickness of the dough.

### BRIEF DESCRIPTION OF THE DRAWINGS

The invention will be better understood in relation to the attached drawings illustrating preferred embodiments, wherein:

FIG. 1 shows a cross-sectional view of a square embodiment of the invention;

FIG. 2 shows a cross-sectional view of a cylindrical embodiment of the invention;

FIG. 3 shows a cross-sectional view of a cylindrical embodiment of the invention with a design in the center portion; and

FIG. 4 shows a cross-sectional view of a cylindrical embodiment of the invention with filling in the center.

### DETAILED DESCRIPTION OF THE INVENTION

A ready-for-use dough product has now been discovered that provides variations in texture, color, and flavor. Consumers can purchase such ready-for-use dough products and conveniently bake them in the home. The dough products typically have at least two zones therein where the dough can be baked to provide a different texture, color, or flavor in the final product. Two different doughs can be used to provide this different texture, color, or flavor. This results in a baked product, such as cookies, that possess this dual texture.

As used herein, the term “bakery dough” refers to pre-mixed doughs of the types used for making bakery items where the dough is generally provided in the form of a sufficiently solid or semi-solid block, while the term “sweet dough” is a species thereof that refers to dough that contains at least 0.5% by weight of sugar or an artificial sweetener, such as saccharine or aspartame. The block is typically provided under refrigerated or frozen conditions, is purchased that way by the consumer, and then is removed from the refrigerator or freezer, thawed if necessary, and then is cut or separated into pieces that are then placed onto a pan or into a baking tin for baking into the final product.

Specific examples of suitable bakery doughs include, but are not limited to, muffins (e.g., jonny cakes, English muffins), crackers (e.g., salted crackers, baked crackers, graham crackers, etc.), rolls (e.g., soft rolls, dinner rolls, crescent rolls), biscuits (e.g., buttermilk biscuits, cobbler biscuits), pie crusts, breads (e.g., focaccia, bruschetta, mixing-for-yeast breads, quick breads, sourdough breads, soda breads, breadsticks, corn bread, etc.), pizza doughs, bagels, and the like, although with increased sugar content some of these types of dough may be formed as sweet doughs. At least in the case of bagels, the dough can be boiled instead of baked. The sweet dough product would typically include a cookie dough, but may also include similar sweet dough products, such as brownies, muffins, turnovers, doughnuts, cakes, pastries, scones, muffins, and the like.

The dough product of the invention can include bakery dough, sweet dough, or both. For example, a product can be prepared with one sweet dough and one bakery dough to provide different textures and/or flavors. The block will typically be in a cylindrical (“chub pack”) or rectangular prism form, although many different shapes for the block are possible, as will be readily envisioned by those of ordinary skill in the art, and as recited in greater detail below. The dough product is typically cut into smaller pieces, such as those that can be baked into individual cookies or other dough products. The consumer simply cuts a desired thickness of the dough from the block. To assist in providing optimal sizes, an imprint, marking or cut line can be provided on the body or upper surface of the block. In this way, individual baked items can be made.

A knife is typically used to completely cut pieces from the block of dough. The pieces are then placed on a pan or sheet and baked. There is no waste due to shaping, and no manipulation is required, other than cutting of the dough by the consumer prior to baking. The dough is formulated to flow upon baking and the pieces may be baked on a sheet or pan that allows them to flow to form shaped, e.g., substantially round, baked products, if desired. In another embodiment, the pieces are first separated, but are baked in a single pan to facilitate a more uniform baking of the pieces.

The dough will typically include a leavening agent, flour, fat, and optionally sugar, although sugar is present in the case of sweet doughs. Other optional ingredients include a texturing agent, and a flavoring agent. The leavening agent is typically present in an amount of about 0.1% to 3% by weight. The flour content of the dough product is about 10% to 60%, preferably about 20% to 40%, and more preferably about 27% to 34% by weight. Sugar or a sugar substitute is typically present in sweet doughs in an amount of about 5% to 50%, preferably about 10% to 40% by weight. In the bakery dough embodiment, the sugar content of the dough is preferably 0.5 weight percent or less, preferably about 0.3 weight percent or less, more preferably about 0.1 weight percent or less. In one bakery dough embodiment, the dough is completely free of sugar. The fat may be of plant or animal origin, such as lard, butter, margarine, or any of various oils, and is typically present in an amount of about 5% to 33% by weight. Preferably, the texturing agent is egg or egg white and when included is present in an amount of about 0.1% to 10%, more preferably about 2% to 5% by weight. The flavoring agent may be natural or artificial and when included is typically present in an amount of about 0.01% to 8%, preferably about 0.25% to 7% by weight. The dough should also have a moisture content of about 2% to 25%, preferably about 8% to 22%, and more preferably about 12% to 16% by weight. This dough can provide a preferred type of cookie dough, while addition of cocoa powder can provide a suitable recipe for brownie dough.

A first dough formulation is used for part of the block, while a second dough formulation is used for another part of the block. The dough formulations can be entirely different, for example, with the first dough being that of a sugar cookie and the second being that of a brownie. Alternatively, the same dough, but with different properties, e.g., moisture content, can be used. In the simplest arrangement, a strip of the first dough is placed adjacent to the second dough. When the block is cut, the resulting pieces contain the two doughs, such that when baked, the resulting product has portions with different textures.

Optionally, either portion of the dough or both may contain inclusions. Inclusions include, but are not limited to, chocolate pieces, oat flake pieces, raisins, fruit pieces, whole nuts or nut pieces, e.g., groundnuts, hazelnuts, or other nuts, caramel, or various mixtures thereof. In one preferred embodiment, the center portion is substantially or completely free of inclusions. The inclusions can be of any edible size, and are typically about 1 mm to about 25 mm, preferably about 4 mm to about 10 mm in diameter. The amount of inclusions, when added to one or both portions of dough, is not critical and can vary from about 1% to 30% by weight. Optionally, dark chocolate, milk chocolate, white chocolate, compound coatings, or mixtures thereof, may be used in the form of morsels, pellets, or chunks. Typically, chocolate is present in an amount of about 5% to about 50%, preferably about 10% to about 30% by weight. The chocolate can be a commercial chocolate or a chocolate of the type used in pastry making or in catering. Preferably, the inclusions are present in the edge portion, rather than the center portion. Preferably, the inclusions are sufficiently small that they do not inhibit any designs present on the product or interfere with the boundary between the dough portions.

In one embodiment, it is possible for the block of dough to have a filling for each piece, the filling being different from the basic dough, i.e., being made from a different material or having a different viscosity. The filling can be either a creamy or a liquid filling, or even a paste in terms of viscosity. The filling can be a sugar-based confection, such as caramel, chocolate, or a liquid filling. The filling can also be a solid filling, such as chocolate, a flavored dough, or another aromatized dough. Other possible fillings may include fruit jams, sugars, puddings, ice cream, soft candy formulations, chewing gum, and the like. For bakery/non-sweet doughs, the filling may include cheese, sauce, spice, meat, chicken, fish, or the like. These types of fillings could also be used as a topping over the bakery dough product, such as cheese and/or tomato on bruschetta or focaccia bread, although care must be taken so that toppings do not contact the cooking surface and cause unsightly charring or a burned flavor or sensation in the baked dough product. Any of these fillings can be used in combination for a suitable filling, e.g., caramel and chocolate, or sauce and chocolate, and one or more sweet and non-sweet fillings can even be used separately or in combination with each other. The block with filling is produced either by coextrusion, injection, or by placing the filling on a first dough layer and then putting a second dough layer upon the filling and first dough layer. In a preferred embodiment, two layers of dough are extruded around a filling to provide a filled dough according to the invention. In another embodiment, the filling can be substantially free or even completely free of added sugar. In one preferred embodiment, the added sugar content in the filling is less than 0.5 weight percent, while in another the added sugar in the filling is less than about 0.25 weight percent of the filling.

The dough formulations are typically extruded. Commercially available extruders include those available from Rheon Automatic Machinery Company, Ltd. of Utsunomiya, Japan, Hosokawa Bepex GmbH of Leingarten, Germany, SASIB of Plano, Texas, APV Systems of Rosemont, Ill., and others.

The dough portions, either a single dough with the same base recipe and different properties, or two or more types of different doughs, may be extruded simultaneously into a single dough product that has different properties after baking. For example, one dough may be baked to provide a crispy texture and the other a chewy texture. In a preferred embodiment, the center portion of the dough product would be chewy and soft and the edge portion of the dough product would be relatively crispier and harder. This can be achieved by formulating the doughs with different moisture contents. Then, during baking, the surface area of the edge portion exposed to heat is greater than the exposed surface area of the center portion. The increased surface area helps cause the edge portion to lose more moisture and become crispier and harder than the center portion. The moisture profile would result in the center of the dough product being the moistest and the outer edge being the driest, with the dryness increasing as the distance from the center portion increases after the dough in baked. The dough that forms the center portion can be provided with a higher moisture content to assist in achieving this result. In a preferred embodiment, the center has a moisture content of greater than about 7% and the edge portion has a moisture content of less than about 6%. Alternatively, the dough that forms the center can be formulated as a softer dough. For example, the center portion may be a brownie dough, while the edge portion may include a cookie dough, for example, since consumers of often desire moister brownie products and relatively drier cookie products. In one embodiment, the edge portion may include a cracker-type dough and the center portion may include a roll- or bread-type dough.

In addition, the doughs may be simultaneously extruded or otherwise formed with or as a variety of decorative shapes or designs. These could include holiday shapes, theme shapes, character shapes or faces, and any others that can be devised by those of ordinary skill in the art. Examples of these include, but are not limited to, stars, hearts, Christmas trees, Chanukah menorahs, mouse ears, and many others. Further examples may include a circle, star, heart, tree, animal, or oval. While many different shapes are possible, shapes with rounded corners and edges, or ovals, are preferred, as sharp corners inhibit free flow of dough and make processing generally more difficult. The shapes are preferably used in the center portion of the dough products.

Preferably, the doughs are formulated such that they are not miscible with each other before, during, or after baking. Numerous combinations of textures, colors, designs, and flavors are possible as will be readily envisioned by those of ordinary skill in the art with reference to the description herein. The doughs preferably have well-defined boundaries. To inhibit or avoid bleeding of the different doughs into each other, and to prevent the doughs from bleeding into each other during storage, it is advantageous to utilize doughs having water activities that are as close as possible. Furthermore, refrigeration or freezing of the dough assists in reducing the amount of bleeding. By using dough product within a reasonable time after removal from the refrigerator or freezer, dough bleeding and mixing should not be a problem.

In one embodiment, the dough is prepared as a chub pack, a cylindrical or sausage-shaped form. In this form, the center portion of the dough product has a diameter of about 1.5 cm to 4.75 cm and the width of the edge portion is about 0.25 cm to 1.5 cm. Preferably, the center portion of the dough product has a diameter of about 1.75 cm to 4.5 cm and the width of the edge portion is about 0.5 cm to 1.25 cm. In one most preferred embodiment, the center portion of the dough product has a diameter of about 2 cm to 4 cm and the width of the edge portion is about 0.75 cm to 1 cm. In one embodiment, the width of the edge portion is about 5% to 40% of the diameter of the dough product, preferably about 10% to 25% of the diameter. The center portion of the dough is generally configured to be larger than the predetermined shape in a predetermined shape. In some cases, the volume of the dough can be divided into longitudinal portions, such as halfs, thirds, quarters, etc, with each longitudinal portion being a different dough. When even numbered portions are used, two different doughs can be used, with one alternating in the position that is adjacent to the other. For example, for a quarter circle cylindrical arrangement, a first pair of quarters, namely, those that are opposite each other, can be made of the same dough while the other two quarters that are between the first pair can be made of a different dough. Again, one of ordinary skill in the art can devise a wide range of variations that fall within this general teaching.

Instead of a cylinder, the dough product can be shaped in the form of a block having a square, rectangular, triangular, oval, or other cross-sectional configuration. These configurations can be used to form cookies or other sweet or bakery dough products of similar shape, or the doughs can be formulated to flow upon baking so that the baked products have a circular or round baked periphery. The dough is generally cut into smaller pieces prior to baking. If the dough is shaped into a disk or cylinder, the cylinder typically has a diameter of about 2 cm to 8 cm, and preferably about 3 cm to 6 cm. If the block is shaped into a prismatic block, typically, the prismatic block has a perimeter of about 1 cm to 8 cm. Preferably, the block of dough is precut into parallelepipedal blocks or disks having a thickness of about 0.5 cm to 5 cm, preferably about 1 cm to 3 cm.

In another embodiment of the invention, the dough product is in the form of a sheet or block with at least two layers. The dough product may also be present in at least two different adjacently positioned strips where each piece is taken from the block. The pieces may also have different colors and two different color doughs may be swirled together to provide a marbled appearance. A variety of sizes and shapes of dough product may be envisioned by those of ordinary skill in the art, all of which are included in the scope of the invention.

When the dough product is configured in the form of a sheet or flat block, it is possible to utilize a topping on the upper surface of the dough. The topping can be any of the components described herein as inclusions as well as those described as fillings. One of ordinary skill in the art can best select the desired components to use on the specific dough products of the invention.

The dough product may be refrigerated or frozen prior to use. Typically, the product is refrigerated at a temperature of less than about 50° F. (10° C.), preferably about 32° F. to 40° F. (0° C. to 4.5° C.) for storage or display before being baked. The difference in texture, color, and flavor will be clearly evident after baking the dough product although the color difference is typically apparent even before baking. The product can typically be baked for about 10 to 15 minutes at about 338° F. to 356° F. (170° C. to 180° C.).

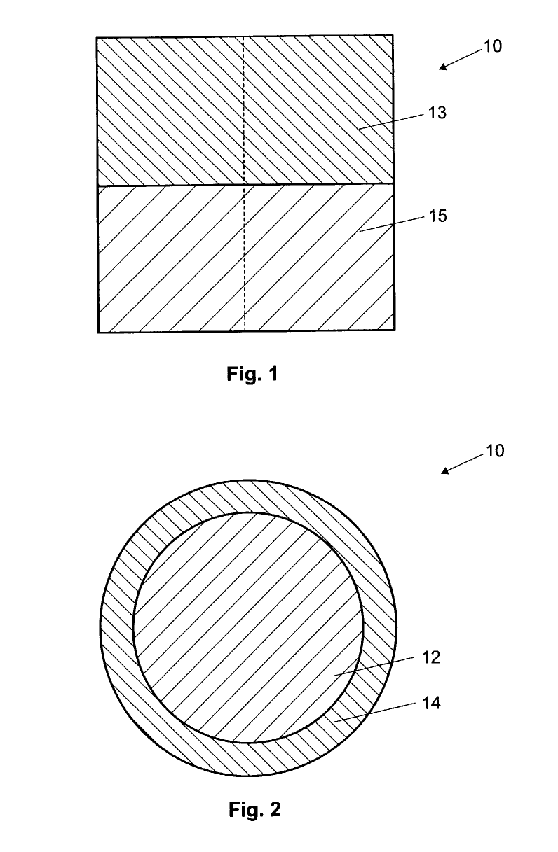

Referring now to FIG. 1, the dough product 10 is shown in square form and has a first dough portion 13 and a second dough portion 15. The first dough portion 13 is formulated to have a different texture, color, and flavor from the second dough portion 15 after the product is baked. This is accomplished by using different doughs for the first 13 and second 15 dough portions, or by varying other properties of the first 13 and second 15 dough portions, such as the moisture content. The first 13 and second 15 dough portions may be further divided into additional portions having additional doughs with differing textures after baking. These portions need not necessarily be symmetrical.

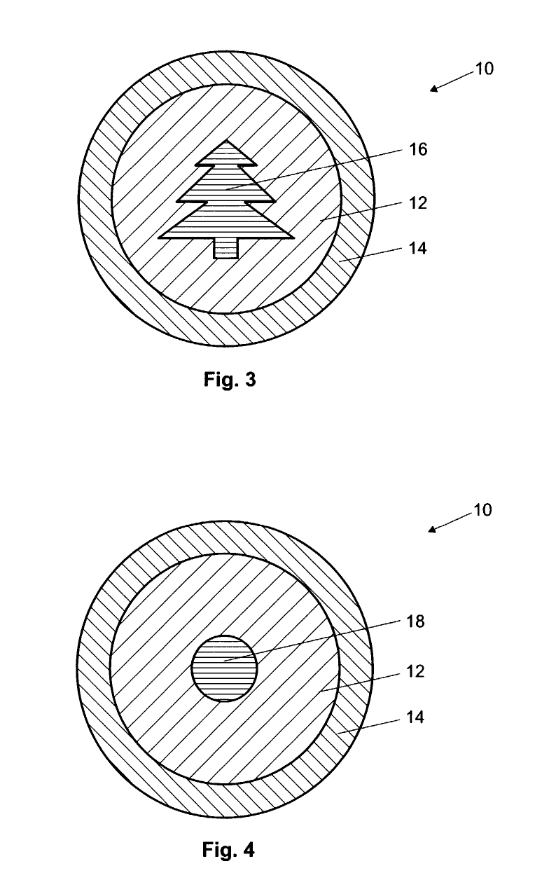

FIG. 2 shows a cylindrical embodiment of the dough product 10 has a center portion 12 and an edge portion 14. The center portion 12 is formed of a first dough and the edge portion 14 is formed from a second dough. The dough of center portion 12 of the dough product 10 has different properties from the dough of the edge portion 14. The dough of the center portion 12 is formulated to have a different texture and color from the dough of the edge portion 14. FIG. 3 shows the dough product 10 with a design 16 in the center portion 12. The design 16 is a different color and flavor from the dough of the center portion 12 or the dough of the edge portion 14. The difference in texture is also present between dough of the center portion 12 and the dough of the edge portion 14. The design 16 preferably has the same texture as the dough of the center portion 12. In another embodiment (not shown), the design is the center portion, i.e., the center is shaped as desired, rather than substantially round as depicted in FIG. 2. FIG. 4 shows the dough product 10 with a filling 18 within the center portion 12. The filling 18 may be a different material or have a different viscosity from the dough of the center portion 12 and the edge portion 14, as described above.

The term “about,” as used herein, should generally be understood to refer to both numbers in a range of numerals. Moreover, all numerical ranges herein should be understood to include each whole integer within the range.

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A ready-for-use dough product comprising:
a first dough portion; and
a second dough portion;
wherein the dough portions are associated with each other for simultaneous baking, with the first dough providing a different texture and color, a different texture and flavor, or a different texture, color, and flavor from the second dough portion after the dough product is baked.

2. The dough product of claim 1, wherein the first dough portion is surrounded by the second dough portion so that the first dough portion forms a center portion of the product and the second dough portion forms an edge portion of the dough.

3. The dough product of claim 2, wherein the center portion is made of a first dough formulation and the edge portion is made of a second dough formulation that is different from the first dough formulation.

4. The dough product of claim 2, wherein the center dough portion is formulated to be softer than the edge dough portion after baking.

5. The dough product of claim 2, wherein the center dough portion is chewier than the edge dough portion after baking.

6. The dough product of claim 2, wherein the center dough portion is formulated to have a moisture content of greater than about 7% after baking and the edge dough portion is formulated to have a moisture content of less than about 6% after baking.

7. The dough product of claim 2, wherein the dough product is at least substantially cylindrical and the center dough portion is configured to have a periphery which forms a design.

8. The dough product of claim 7, wherein the center dough portion has a circle, star, heart, tree, animal, or oval shape.

9. The dough product of claim 2, wherein the center dough portion comprises brownie dough and the edge dough portion comprises cookie dough.

10. The dough product of claim 1, in the form of a cylinder or polygon having an outer perimeter of between about 1 cm to 8 cm and a length of about 10 cm to 25 cm.

11. The dough product of claim 1, wherein one or both of the first and second dough portions include pieces of chocolate, nuts, fruit, or candy inclusions in an amount of about 5% to 50% by weight of the dough, wherein the pieces are about 1 mm to 10 mm in size.

12. The dough product of claim 1, wherein the first and second dough portions are sufficiently viscous to inhibit or avoid miscibility thereof.

13. The dough product of claim 1, wherein the first and second dough portions are arranged to be longitudinally adjacent each other in the form of strips or longitudinal sections.

14. The dough product of claim 1, wherein the first and second dough portions each comprise a different bakery dough for forming a muffin, cracker, roll, biscuit, pie crust, bread, pizza dough, or bagel portion.

15. The dough product of claim 2, in sheet or block form having a generally uniform thickness and a surface that includes an imprint of grooves, score lines, or combinations thereof that defines pieces of the dough to be broken off and baked, with the imprint extending into the thickness of the dough product.

16. The dough product of claim 15, wherein the imprint does not extend entirely through the thickness of the dough.

17. A method of providing a dough product that comprises:
providing first and second doughs which are formulated to differ in texture, color, and flavor after the dough product is baked; and
associating the doughs together to form a dough product that can be baked so that, after cutting and baking, a baked product having portions with different textures is obtained.

18. The method of claim 17, wherein the first and second doughs are co-extruded such that the first dough forms a center portion of the dough product and the second dough forms an edge portion of the dough product that surrounds the center portion.

19. The method of claim 18, wherein the center dough portion is formulated to be softer than the edge dough portion after the dough product is baked.

20. The method of claim 18, wherein the center dough portion is formulated to be chewier than the edge dough portion after the dough product is baked.

21. The method of claim 18, wherein the center dough portion is formulated to have a moisture content of greater than about 7% and the edge dough portion is formulated to have a moisture content of less than about 6% after the dough product is baked.

22. The method of claim 17, wherein the first and second doughs are formulated to be sufficiently viscous to inhibit or avoid miscibility thereof.

23. The method of claim 17, wherein the first and second doughs are arranged to be longitudinally adjacent each other in the form of strips or longitudinal sections.

24. The method of claim 17, wherein the dough product is coextruded in sheet or block form having a generally uniform thickness wherein the edge portion has a surface that includes an imprint of grooves, score lines, or combinations thereof, that defines pieces of the dough to be broken off and baked, with the imprint extending into the thickness of the dough.

25. The method of claim 24 wherein the dough is stored in a refrigerated or frozen state prior to use and the imprint does not extend entirely through the thickness of the dough.
